(19) United States
(12) Patent Application Publication
(10) Pub. No.: US 2026/0021795 A1
(43) Pub. Date: Jan. 22, 2026

(54) METHOD AND BRAKE SYSTEM FOR ACTUATING A BRAKE ACTUATOR IN ORDER TO REDUCE TENSIONING OF A VEHICLE

(71) Applicant: ZF CV Systems Europe BV, Brussels (BE)

(72) Inventors: Axel Stender, Hameln (DE); Christoph Schowe, Gehrden (DE); Felix Diet, Rodenberg (DE); Marcel Winkel, Hannover (DE)

(21) Appl. No.: 19/337,510

(22) Filed: Sep. 23, 2025

Related U.S. Application Data
(63) Continuation of application No. PCT/EP2024/056717, filed on Mar. 13, 2024.

(30) Foreign Application Priority Data
Mar. 23, 2023 (DE) 10 2023 107 310.9

(51) Int. Cl. B60T 7/20; B60T 8/17; B60T 8/171; B60T 8/18

(52) U.S. Cl. CPC B60T 7/20; B60T 8/1708; B60T 8/1843; B60T 8/185; B60T 8/171

(57) ABSTRACT

In a method for actuating a brake actuator in a braked, stationary vehicle, a state variable defining a state of loading of the vehicle is monitored and a stress in the vehicle produced by a level change is detected. The state variable is compared with a predefined value range and the brake actuator is released in response to the detection of a stress. For the case wherein the state variable can be assigned to the predefined value range, a first target braking level is actuated and/or, for the case in which the state variable cannot be assigned to the predefined value range, a second target braking level is actuated.

### CROSS-REFERENCE TO RELATED APPLICATIONS

This application is a continuation application of international patent application PCT/EP2024/056717, filed Mar. 13, 2024, designating the United States and claiming priority from German application 10 2023 107 310.9, filed Mar. 23, 2023, and the entire content of both applications is incorporated herein by reference.

### TECHNICAL FIELD

The present disclosure relates to a method for actuating at least one brake actuator via a brake system in a braked, stationary vehicle with the aim of dissipating stressing of the vehicle produced by a level change.

### BACKGROUND

Such a vehicle can in particular be a commercial vehicle. Vehicles or commercial vehicles of the type mentioned at the beginning are provided with a suspension for springing a vehicle body. Such a suspension can be, for example, a mechanical suspension or a pneumatic suspension. Because of the suspension, the height of the vehicle body over the wheels or axles is not constant. During loading, the height decreases, during unloading the height increases. The change in the height of the vehicle body relative to the wheels or axles is also designated a level change. In particular in vehicles with pneumatic suspension, it is possible to adapt the height actively via pneumatic level control, for example via manual or automatic activation of the pneumatic suspension. This also applies to trailer vehicles and semi-trailer trucks.

In many vehicles, the axles of the wheels are mounted on longitudinally directed axle swinging arms or trailing arms. During each level change, caused by the change in the height of an axle, the relevant axle swinging arm moves over a fraction of a circular path. It is possible for a change in the wheelbase to occur, that is, a change in the distance between the rear wheels and front wheels, depending on the position of the axle swinging arm on its circular path. As a result of the changed wheelbase, stresses occur, the wheels having to rotate through a small angle to compensate for the stressing of at least one axle. The loading of vehicles is typically carried out with a braked, stationary vehicle. In this case, the wheels of each of the axles of the vehicle are preferably braked. The braking of the axles and the wheels is carried out by a brake actuator, which is configured to provide a brake function, preferably a service brake function or a parking brake function.

For example, to provide a parking brake function, the brake actuator is tightened in such a way that a number of brake pads can be mechanically pressed freely onto a respective corresponding brake disk or brake drum via spring force, without the brake actuator applying a counteracting force. A brake force can also be applied by tightening the brake actuator itself, for example electrically.

As a result of providing a brake function via the brake actuator, the wheels are no longer rotatable, so that a change in the wheelbase cannot be compensated. Stresses of different intensity are produced in the vehicle, depending on the respective level change.

The problem of stressing also occurs in a semi-trailer truck, that is, a combination of tractor and semi-trailer. The wheelbase between rear wheels of the tractor, on the one hand, and the wheels of the semi-trailer, on the other hand, is relevant. Finally, the stressing described can occur on all vehicles or semi-trailer trucks in which the level change leads to a change in the wheelbase, therefore, for example, also in a combination of a motor vehicle and drawbar trailer.

EP 1 800 916 B1 discloses a method for compensating for the described stressing. In the event of a change in the level of the vehicle body with respect to its wheels, during or after the same, the stresses are dissipated automatically via alternately completely releasing the brake actuator. The disadvantage with the known method is the relatively high air consumption as a result of the complete releasing and re-tightening of the brake actuator.

DE 100 2014 012 549 discloses a method which solves the problem of the increased air consumption in that the brake actuators are released on both sides while maintaining a minimum braking level. This minimum braking level is, however, not matched to the actual load states of the vehicle. The maintained minimum braking level is therefore often over-dimensioned in order to meet statutory specifications. As a result, intense stresses cannot be dissipated completely under certain circumstances, since the maintaining minimum braking level is too high to ensure adequate rotation of the wheels.

### SUMMARY

It is e an object of the present disclosure to overcome at least one of the disadvantages known from the prior art. In particular, it is an object of the present disclosure to dissipate the stresses produced by a level change in vehicles more effectively and preferably entirely.

The disclosure achieves the basic object via various embodiments of the disclosure.

In relation to a method of the type mentioned at the beginning for actuating a brake actuator—wherein a plurality of brake actuators can be controlled—, the disclosure proposes that the method includes the following steps:
a) monitoring a state variable which characterizes a state of loading of the vehicle—wherein a plurality of state variables can be monitored-,
b) detecting a stress in the vehicle produced by a level change,
c) comparing the state variable with a predefined value range, and
d) releasing the brake actuator in reaction to the detection of a stress, wherein in the case in which the state variable can be assigned to the predefined value range, a first target braking level is actuated and/or in which the state variable cannot be assigned to the predefined value range, a second target braking level is actuated.

In the sense of the disclosure, a state of loading is to be understood as each state of the vehicle or of a semi-trailer truck which has a direct or at least indirect influence on the required braking force. In this connection, a state variable is a value that can be measured indirectly or directly, which characterizes the state of loading and thus, directly or at least indirectly, permits the required braking force to be inferred. In the present case, a target braking level is understood to be a reduced braking level as a percentage compared with the complete braking of the vehicle. In the sense of the disclosure, a level change is to be understood both as an active and as a passive level change.

In the sense of the disclosure, a state variable cannot be assigned to a predefined value range for the case in which it lies outside the value range or cannot be determined unambiguously.

To dissipate a stress in a stationary, braked vehicle it is necessary to reduce the braking force temporarily and thus to permit rotation of at least one axle of the vehicle. Releasing the brake actuator in this connection describes the reduction in the braking force via appropriate actuation of the brake actuator.

In the method according to the disclosure, in addition to the detection of a stress in the vehicle, additional information, specifically the current state variable, is monitored and processed. This permits exact control of the brake actuator while taking the current state of loading of the vehicle into account. Thus, when the brake actuator is released, it is possible to react to varying load states. As a result of releasing the brake actuator while actuating a second predefined target braking level as a function of the detected state variable, in the method according to the disclosure account is also taken of the situations in which the state of loading does not permit any determination of the target braking level as a function of the state variable.

The first target braking level can be defined as a function of the state variable. Therefore, more exact and load-based releasing of the brake actuator as a direct reaction to changed load states of the vehicle is possible. Safety-based over-dimensioning of the braking because of a lack of accurate knowledge of the state of loading of the vehicle is thus no longer necessary.

It is preferred for step b) to be carried out before step c). More preferably, steps a) to d) are carried out successively. Thus, a comparison of the in particular permanently monitored state variable with the predefined value range takes place only for the case in which a stress is detected in step b).

According to one embodiment, at least step a), in particular step a) and step b), are carried out continuously and steps c) and d) are carried out for the case in which a stress is detected in step b).

According to a further embodiment, the state variable is a first state variable which characterizes a first state of loading and which is compared with a first predefined value range in step c), wherein a second state variable which characterizes a second state of loading of the vehicle is also monitored in step a).

In particular, the second state variable can be compared with a second predefined value range in step c). Thus, various value ranges are taken into account and the brake actuator is controlled as a function of two different state variables and corresponding value ranges.

According to an alternative, the first state variable and a second state variable characterize the state of loading and both state variables are compared with the first predefined value range in step c). Thus, a state of loading of the vehicle is monitored better and, in particular, it is possible that interactions of the state variables are also taken into account.

Further, in step d), the first target braking level can be actuated for the case in which the first state variable can be assigned to the first predefined value range and the second target braking level can be assigned to the second predefined value range and, in step d), a third target braking level can be actuated for the case in which the second state variable (Z₂) cannot be assigned to the second predefined value range. In this case, the first state variable can preferably be assigned to the first value range. Thus, the influence of the two state variables on the required braking force, and therefore the target braking level to be actuated, is taken into account. The disclosure advantageously recognizes that in situations in which at least the first state variable can no longer be assigned to the first value range, a second target braking level, different from the first target braking level, is to be actuated. In addition, the disclosure recognizes that in situations in which at least the second state variable cannot be assigned to the second value range, account can also be taken of this individual state of loading by actuating a third predefined target braking level, which is different from the first target braking level and the second target braking level. In the case in which neither the first state variable nor the second state variable can be assigned to the predefined value range, in particular a fourth target braking level can be actuated. Thus, the safety of the vehicle is increased by the individual coordination with the different load states and, at the same time, stresses can be effectively dissipated.

In particular, at least one state of loading is a positional state and the state variable is an angle of inclination of the vehicle relative to the horizontal. In the present case, a positional state is understood to be the inclination of the vehicle relative to the horizontal which, for example, is caused by a slope of the road.

Furthermore, the angle of inclination can be monitored by sensing an acceleration of the vehicle via a sensor unit. As a result of the respective positional state, slope downforces act on the vehicle, which have a direct influence on the required braking force. The braking force must overcome the slope downforce, which is a function of the angle of inclination. Thus, as a result of the monitoring of the acceleration of the vehicle, the angle of inclination can be determined, which in this way can in particular be monitored continuously. Depending on the angle of inclination, the brake actuator can then be controlled and the angle of inclination can be compared with the predefined value range, in particular in the event of detection of a stress, and, if necessary, be used to determine the target braking level.

According to a further embodiment of the method, the predefined value range includes angles of inclination in a range of |0°<α≤|±90°|, in particular of 0°<α≤|+12°|. Furthermore, the predefined value range can include angles of inclination in a range of 0°<α≤|±7°| or |±7°|<α≤|±10°|.

In particular, the first target braking level can be defined as a ratio of the braking force f_{b}(α)=m·g·sin α and the weight f_{g}=m·g in %, and the second target braking level can assume a value≤1%. Thus, the first target braking level is defined as f_{g}/f_{b}(α) and, for a value range of the angle of inclination of 0°<α≤|+90°|, in particular a value range of 0<α≤|±12°|, a first target braking level is determined as a function of the angle of inclination. If the state variable lies outside this value range or cannot be determined, it can thus not be assigned. In this case, the brake actuator is controlled with a second target braking level. This is the case, for example, in a vehicle standing on a level, the angle of inclination corresponding to 0°. In this case, no slope downforces act on the vehicle and the second target braking level can assume a discrete value≤1% and the brake actuator can be released completely. Thus, the stress of the vehicle is completely eliminated quickly and efficiently, since the wheels are braked only with a second target braking level≤1%.

According to a further embodiment, at least one state of loading is a state of loading and the state variable is a pressure which characterizes the state of loading of the vehicle. In the present case, a state of loading of the vehicle is understood as the weight and/or the distribution of the load and the associated distribution of the axle load of the vehicle.

The level of the vehicle or vehicle body can be controlled actively by controlling the pressure in a pressure-regulated suspension of the vehicle. This is used, for example, in order to react to changed states of loading. At the same time, a changed arrangement or a changed weight of the load leads to a change in the axle load distribution and therefore to a pressure change in the suspension. Monitoring the pressure thus permits the state of loading of the vehicle to be inferred. As a result of monitoring the pressure, releasing the brake actuator more exactly is thus possible in the method according to the disclosure. However, under certain circumstances the weight or the distribution of the load cannot be determined by monitoring the pressure for example when loading an empty vehicle. When loading the vehicle, the vehicle body can be lowered by the suspension. In this case, the pressure cannot be assigned unambiguously to a predefined value range, so that a second predefined target braking level is actuated. This can, for example, correspond to the so-called loading characteristic, that is the braking required in a fully loaded vehicle.

It is possible for the state of loading to be monitored by sensing an air suspension bellows pressure of a pneumatic suspension or of a hydraulic pressure of a hydraulic suspension of the vehicle via a sensor unit.

A pneumatic suspension or air suspension system of a vehicle includes an air supply and a bellows connection for the connection of one or more air suspension bellows to the air supply, and also a valve, in particular a solenoid valve, for blocking or opening a connection between the air supply and the bellows connection. The pneumatic suspension or air suspension system can include a plurality of valves. The level of the vehicle or vehicle body can be controlled actively by controlling the pressure in the air suspension bellows. In addition to this active level change or level regulation, in particular passive regulation of the level of the vehicle body above the axles can take place as a result of the loading of the vehicle. As a result of this passive level change resulting from a changed arrangement or changed weight of the load, just like in the case of an active level change, the pressure in the air suspension bellows changes, the pressure in the air suspension bellows being monitored by the sensor unit. In order to actuate the brake actuator of an air-sprung vehicle, the sensing of the air suspension bellows pressure permits a changed weight of the load and also in particular its distribution to be inferred. Thus, the sensor unit is configured to detect a stress produced by an active and a passive level change.

In particular, the predefined value range in a pneumatic suspension or air suspension system can include pressures in a range of 0.1 bar<p<10 bar, in particular in a range of 1 bar<p<6 bar. Furthermore, the second target braking level can correspond to the maximum target braking level in a fully loaded vehicle.

In the case of a hydraulic suspension of the vehicle body, the hydraulic pressure is also monitored by the sensor unit in the method according to the disclosure. Passive level changes caused by the change in the position or the weight of the load of the vehicle body are monitored via differences in the hydraulic pressure. Furthermore, the pressure can be controlled actively for an active level change. A change in the hydraulic pressure permits a change in the vehicle weight or the distribution of the load of the vehicle to be inferred. Thus, the first target braking level can be determined as a function of this state variable.

In particular, the predefined value range of a hydraulic suspension can include pressures in a range of 2.5 bar<p<200 bar. Furthermore, the second target braking level can correspond to the maximum target braking level in a fully loaded vehicle.

In particular, at least one state of loading can be a state of loading and the state variable can be a spring compression travel of a mechanical suspension, which characterizes the state of loading of the vehicle. In the case of a mechanical suspension of the vehicle or of the vehicle body, spring compression of the vehicle body or in particular of an axle unit occurs in the event of a change in the weight or the distribution of the load of the vehicle or of the vehicle body. Monitoring the change in this spring compression travel via a sensor unit thus permits a suitable state variable to be provided, as a function of which a target braking level can be actuated by the brake actuator.

Furthermore, in step b), stressing of the vehicle can be detected for the case in which the following conditions are fulfilled:
a) the vehicle is at a standstill, and
b) the vehicle is braked, and
c) a level change falls above or below a limiting value.

Whether the vehicle is braked can be gathered from the status of the at least one brake actuator, in the case of an electro-pneumatically actuatable brake actuator, in particular also from the brake control pressure. In particular, the brake actuators for activating a parking brake function can be actuated by a control device of a brake system and the activation can be detected in order to detect a braked state of the vehicle. The level change can be gathered from the signals from a displacement sensor assigned to an axle. The level change is calculated as the difference between a currently detected level and the neutral position, wherein the neutral position is detected and stored when the service brake or parking brake is released. The level change is preferably intended to be at least ±20 mm with respect to an initial position. The initial position is also designated as the neutral position below.

In particular, the conditions are polled successively one after another and the respectively following condition is polled only when the preceding condition has been fulfilled.

In particular, the vehicle has at least one axle, wherein the axle is in each case assigned two brake actuators, which are actuated simultaneously in step d). It should be understood that simultaneous actuation of the two brake actuators is to be understood as referring to time and also includes actuation with different control pressures and target braking levels.

The disclosure has been described above in a first aspect in relation to a method.

In a second aspect, the disclosure achieves the object mentioned at the beginning via a brake system, in particular an electronically controllable pneumatic brake system, for a vehicle for actuating a brake actuator, including:
a sensor unit for monitoring a state variable which characterizes a state of loading of the vehicle—wherein the sensor unit can be configured to monitor a plurality of state variables—
a displacement sensor for detecting a stress in the vehicle produced by a level change, and
a control device which has a signal connection to the sensor unit and the displacement sensor and which is configured to release the brake actuator in reaction to the detection of a stress and, for the case in which the state variable can be assigned to the predefined value range, to actuate a first target braking level, and/or in which the state variable cannot be assigned to the predefined value range, to actuate a second target braking level.

In particular, the first target braking level can be defined as a function of the state variable.

As a result of the fact that the control device has a signal connection to the sensor unit and the displacement sensor and is configured to release the brake actuator as a function of the monitored state variable by actuating a first target braking level or a second target braking level, the brake system according to the disclosure adopts the advantages described in relation to the method according to the first aspect of the disclosure. Possible embodiments in relation to the first aspect of the disclosure are likewise possible embodiments in relation to the second aspect of the disclosure and vice versa.

In particular, the brake system can be configured to carry out a method according to the first aspect of the disclosure.

The brake system can be an electronically controllable pneumatic brake system, and the brake actuator can be an electronically regulated pneumatic brake actuator.

The electro-pneumatic brake system can include an in particular single-circuit electro-pneumatic system component with the control device, an axle modulator assigned to one of the axles, a braking value transmitter and two ABS valves assigned to one of the axles. Such a control device is also designated a central module. The brake actuator can include a brake cylinder, and the axle modulator can have a signal connection to the control device. The control device can be configured to actuate the axle modulator as a function of the signal from the braking value transmitter, so that the axle modulator regulates the brake cylinder pressure on both sides of one or two axles.

If the vehicle is coupled to a trailer, the electro-pneumatic system component in particular also includes an electro-pneumatic trailer control valve. The electrical actuation and monitoring are preferably carried out by the control device.

The brake actuator can be configured to provide a service brake function, wherein, as a result of releasing the brake actuator by actuating a first target braking level or the second target braking level, the braking by the service brake function of a braked vehicle is reduced.

The brake system can be an electric brake system, and the brake actuator can be an electric brake actuator, for example a servo drive. The response times are reduced by an electric brake actuator.

Furthermore, the brake actuator can be configured to provide a parking brake function, wherein, as a result of releasing the brake actuator by actuating a first target braking level or the second target braking level, the braking by the parking brake function of a braked vehicle is reduced. Such a parking brake function, which is actuated automatically when a vehicle is at a standstill, is also designated as a parking brake function.

Furthermore, at least one state of loading can be a positional state and at least one state variable can be an angle of inclination of the vehicle relative to the horizontal, wherein the sensor unit has an acceleration sensor for monitoring the angle of inclination. An acceleration sensor permits the monitoring of the longitudinal acceleration acting on the vehicle, which depends on the slope downforce and thus the angle of inclination of the vehicle relative to the horizontal. As a result of monitoring the acceleration of the stationary vehicle via an acceleration sensor, the angle of inclination of the vehicle can thus be monitored reliably.

According to a further embodiment, at least one state of loading is a state of loading and at least one state variable is a pressure of a suspension, and wherein the sensor unit has a pressure sensor for monitoring the pressure. In vehicles with pneumatic suspension, the pressure sensor is a bellows pressure sensor, which is also designated as an axle load sensor. By detecting the bellows pressure in one or more air suspension bellows, this permits the determination of the axle loads and therefore reliable monitoring of the state of loading of the vehicle. It is only known to use this signal to adapt the braking forces to various states of loading. Beyond this, the inventors have advantageously recognized that the monitoring of the pressure in a braked stationary vehicle can also be used to release the brake actuators to dissipate stresses by actuating a suitable target braking level. The target braking level is selected via a control case distinction of the state of loading and is actuated accordingly, that is, by comparing the bellows pressure with a predefined value range.

In the case of a hydraulically sprung vehicle, a pressure sensor for monitoring the hydraulic pressure of the suspension likewise permits reliable monitoring of the state of loading.

It is also possible that at least one state of loading is a state of loading and at least one state variable is a spring compression travel of a mechanical suspension, in particular an axle unit. The sensor unit in particular has a displacement sensor for monitoring the spring compression travel. The displacement sensor in this application supplies a signal proportional to the spring compression travel and therefore in particular proportional to the current axle load. The monitoring of the spring compression travel in mechanically sprung vehicles permits simple and reliable monitoring of the state of loading.

In a third aspect, the disclosure achieves the object mentioned at the beginning via a vehicle, preferably a commercial vehicle, having at least one axle suspended on trailing arms or semi-trailing arms and a brake system according to the second aspect of the disclosure for actuating a brake actuator assigned to the axle. The vehicle according to the disclosure having a brake system according to the second aspect adopts the advantages described in relation to the first and second aspect. Advantages and possible embodiments of the first and second aspect of the disclosure are likewise advantages and possible embodiments in relation to the third aspect of the disclosure and vice versa.

In particular, the vehicle can be a semi-trailer, in particular an air-sprung semi-trailer, having a tractor having at least one axle suspended on trailing arms or semi-trailing arms and a trailer that can be connected to the semi-trailer and has at least one axle suspended on trailing arms or semi-trailing arms. The brake system can be configured to actuate the brake actuator of the tractor and/or the trailer.

According to an alternative embodiment, the vehicle is a tractor having an axle suspended on trailing arms or semi-trailing arms and a trailer that can be connected to the tractor and has an axle suspended on trailing arms or semi-trailing arms, and a dedicated brake actuator assigned to the axle and having an electro-pneumatic trailer control valve. The brake actuator of the trailer, in particular the trailer control valve, can be configured for actuation in a method according to the first aspect of the disclosure, wherein the actuation can in particular be carried out by the control device of the tractor.

According to a fourth aspect, the disclosure further relates to the use of an acceleration sensor in a method for actuating a brake actuator according to the first aspect of the disclosure, wherein the state of loading is a positional state and the state variable is an angle of inclination of the vehicle relative to the horizontal, and wherein the acceleration sensor is configured to monitor the state variable. Advantages and possible embodiments of the first aspect of the disclosure are likewise advantages and possible embodiments in relation to the fourth aspect of the disclosure and vice versa.

### BRIEF DESCRIPTION OF DRAWINGS

The invention will now be described with reference to the drawings wherein:

FIG. 1 shows a semi-trailer truck with tractor and trailer, wherein the trailer has been lowered once, schematically in a side view;

FIG. 2 shows a semi-trailer truck with tractor and trailer, wherein the trailer has been raised once, schematically in a side view;

FIG. 3 shows a semi-trailer truck with tractor and trailer, wherein the semi-trailer truck is standing on ground with a slope, schematically in a side view;

FIG. 4 shows the semi-trailer truck according to FIGS. 1 to 3, schematically in a top view; and,

FIG. 5 shows a second embodiment of a semi-trailer truck, schematically in a top view.

### DETAILED DESCRIPTION

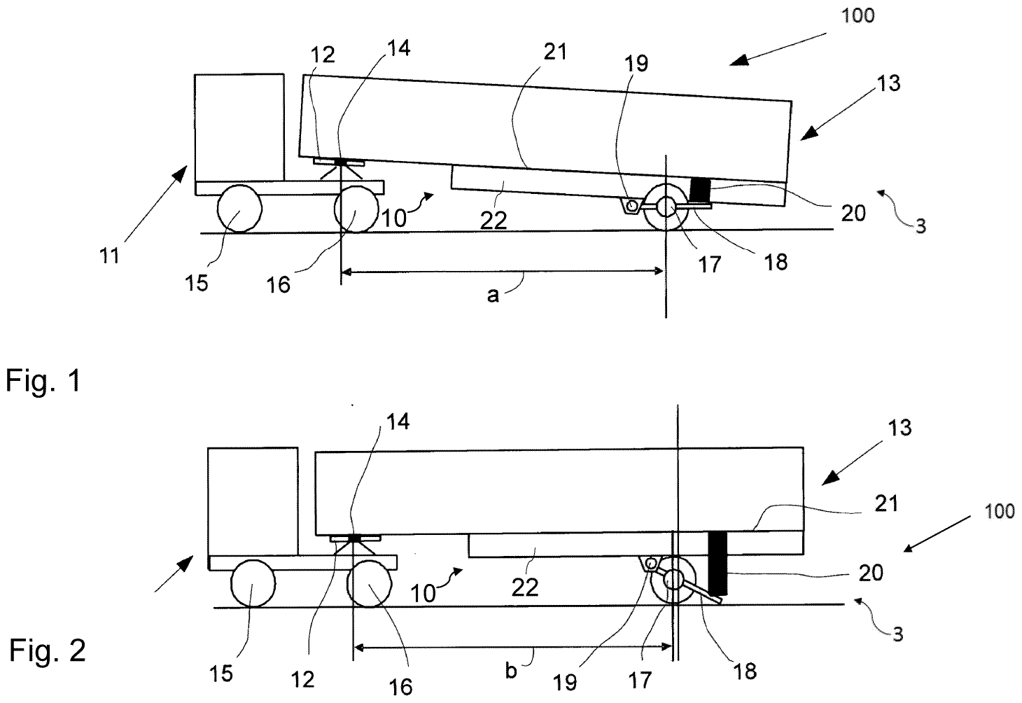

FIGS. 1 to 3 show a vehicle 100. The vehicle 100 in the present case is a semi-trailer, which here includes a tractor 11 with fifth-wheel plate 12 and a trailer 13 with king pin 14.

The tractor 11 has a front axle 15 and a rear axle 16 respectively. The trailer 13 has an axle 17, which is mounted on an axle swinging arm 18. The axle swinging arm 18 is pivotable about a bearing point 19 and forms a trailing arm for the axle 17.

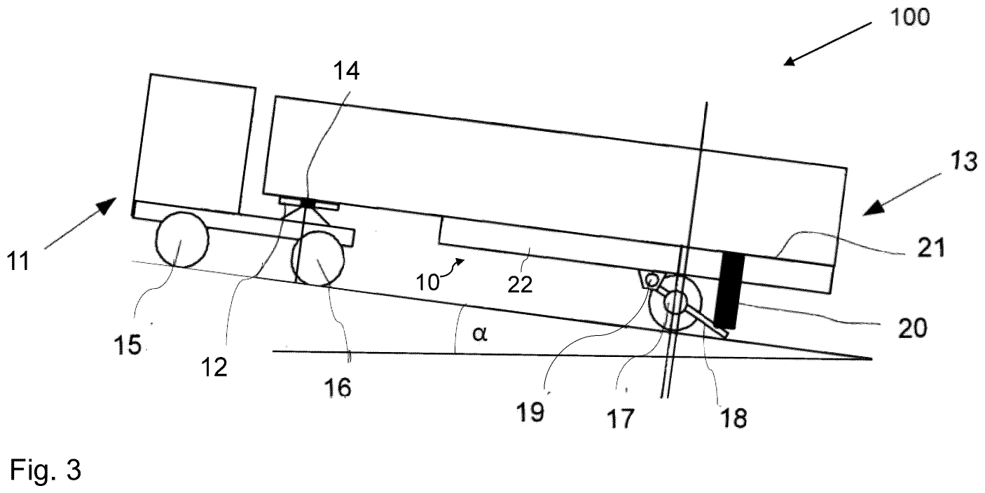

The axle 17 is adjustable in height via an air suspension bellows 20 which acts on the axle swinging arm 18 opposite the bearing point 19. In FIG. 1, the air suspension bellows 20 is minimally filled, while FIG. 2 and FIG. 3 show a maximally filled air suspension bellows 20. In a corresponding way, the level of the trailer 13 is considerably lower in FIG. 1 than in FIG. 2 or FIG. 3. Here, the distance of the axle 17 from the vehicle body 21 of the trailer 13 is designated as the level.

The semi-trailer 100 has an electro-pneumatic brake system 10 and a suspension 3. In the embodiment shown, the suspension 3 is an electronically regulated pneumatic suspension. This permits automatic level regulation during the loading and specific adaptation of the height of the vehicle body 21 to a loading ramp.

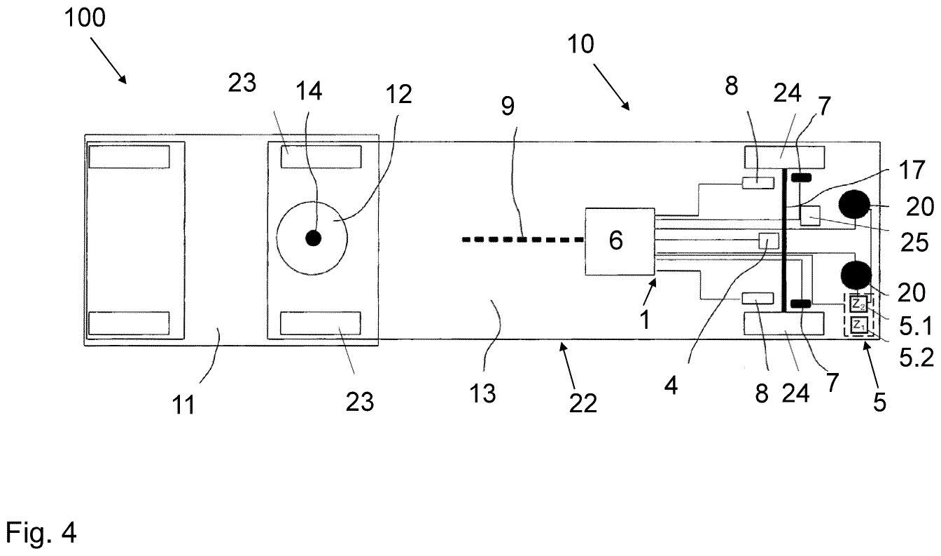

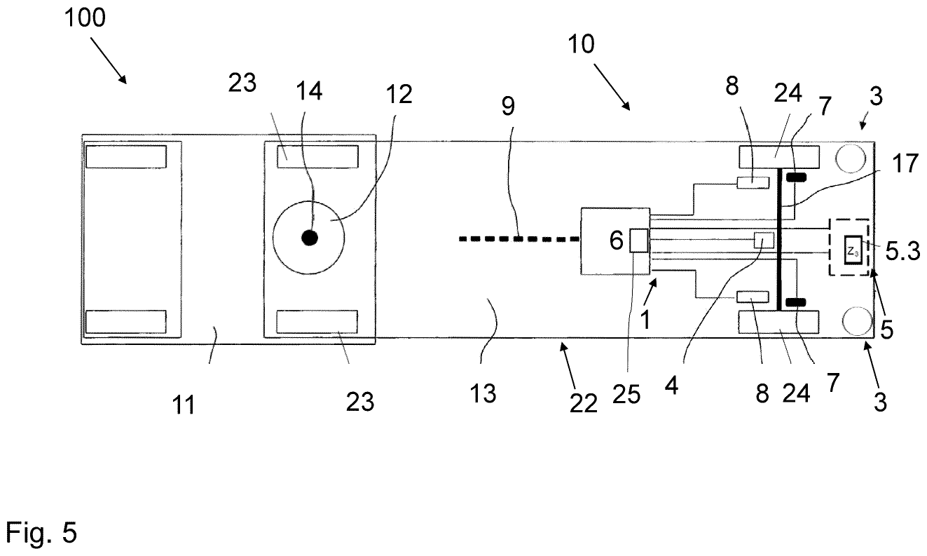

Stressing occurs, for example, between the states illustrated in FIG. 1 and FIG. 2 and FIG. 3. In FIG. 1, the level of the trailer 13 has been lowered for travel. The wheelbase, or, here, the distance between the axle 17 and the king pin 14, is illustrated by a double arrow a. In FIG. 2 and FIG. 3, the level of the trailer 13 has been raised. Accordingly, the axle swinging arm 18 has pivoted downward. As a result, there is a new, shorter distance according to the double arrow b between the axle 17 and the king pin 14 (cf. FIG. 2). When the wheels 23, 24 of the rear axle 16 and the axle 17 are braked, the result is high stress in the trailer 13, which can be so pronounced that, starting from FIG. 1, the state according to FIG. 2 and FIG. 3 cannot be reached. In the meantime, it is necessary to dissipate the stress by at least slightly releasing the parking brake 25 (cf. FIGS. 4 and 5) by actuating the respective brake actuator 8 of the electro-pneumatic brake system 10 via the brake system 1.

FIG. 4 shows the vehicle floor 22 of the semi-trailer 100 according to FIGS. 1 to 3 in detail.

The electro-pneumatic brake system 10 shown in detail in FIG. 4 has an electronically controllable pneumatic brake system 1 in conjunction with a number of electronically regulated pneumatic brake actuators 8 and a compressed air supply (not shown) for the brake actuators 8, wherein at least two brake actuators 8 are assigned to the rear axle 17.

The brake system 1 is configured to detect stressing of the semi-trailer 100 and to release the brake actuator 8 of the electro-pneumatic brake system 10 to dissipate the stress by actuating a target braking level.

The brake system 1 includes, in particular, an in particular single-circuit electro-pneumatic system component with the control device 6, an axle modulator 25 assigned to the axles 17, a braking value transmitter (not shown) and two ABS valves (not shown) assigned to the axles 17. The axle modulator 25 thus has a signal connection to the control device 6. Such a control device 6 is also designated as a central module. The brake actuators 8 preferably each include a brake cylinder (not shown).

The control device 6 is configured to actuate the axle modulator 25 as a function of the signal from the braking value transmitter, so that the axle modulator 25 in particular regulates the brake cylinder pressure on both sides of the rear axle 17.

The brake system 1 also includes a sensor unit 5 and wheel rotational speed sensors 7, which are connected to the control device 6.

The pneumatic suspension 3 is electronically regulated and includes a displacement sensor 4, with which a current level of the axle 17 and changes in the level can be detected. The displacement sensor 4 preferably has a signal connection to the brake system 1, preferably the control device 6. The control device 6 preferably continuously evaluates the signals from the displacement sensor 4, likewise the signals from the wheel rotational speed sensors 7.

The control device 6 additionally receives information about the activation of a brake function, preferably a parking brake function or a service brake function. The control device 6 preferably stores the current level (measured level) of the axle 17 at regular intervals or under specific conditions, specifically as long or as soon as the wheels 24 of the axle 17 are not braked. This stored measured level is designated the neutral position.

Starting from the neutral position, the brake system 1, preferably the control device 6, is configured to detect stress via the signals from the displacement sensor 4.

In the present case, the brake system 1 of the trailer 13 is equipped to dissipate the stress by using an additional function which is substantially located in the function and the software of the control device 6. This detects stressing of the trailer 13 in the manner described above. Furthermore, the brake system 1 monitors at least one state variable Z₁, Z₂ via the sensor unit 5, wherein the brake system 1 with the control device 6 is configured to release the brake actuators 8 as a function of the monitored state variable Z₁, Z₂ for the case in which stress is detected. To dissipate the stress detected by releasing the brake actuators 8, the brake system 1 and, in particular, the control device 6 carries out an actuation of a first target braking level or second target braking level via the brake actuator 8, in particular via appropriate actuation of the respective brake cylinder (not shown) or possible brake valves (not shown). As a result of this additional function of the brake system 1, it is possible to actuate the brake actuator 8 of the semi-trailer 100 as necessary in the various load states shown in FIGS. 2 and 3.

The state variable Z₁ monitored by the sensor unit 5 is in particular an angle of inclination α, and the state of loading characterized by the angle of inclination α is a positional state of the semi-trailer 100. The sensor unit 5 includes an acceleration sensor 5.1 for monitoring the angle of inclination α.

In FIG. 2, the semi-trailer 100 is on a level with an angle of inclination α=0°. In FIG. 3, on the other hand, the semi-trailer 100 is on a slope with an angle of inclination α=10°. These two positional states of the semi-trailer 100 characterized by the angle α each require a coordinated minimum braking level in order to prevent the semi-trailer 100 unintendedly rolling away when the brake actuators 8 are released.

The control device 6 is additionally connected via a standardized data connection, in the present case a CAN bus system 9, to an electronic system, not shown in more detail, of the tractor 11. The function, constituent parts and interaction of the aforementioned systems are in principle known. Only the constituent parts that are significant for the understanding of the disclosure are shown in the figures.

Releasing the brake actuator 8 is only briefly envisaged. After the stress has been dissipated, the brake pressure is increased again to the originally applied value. The time interval during which the reduction in the braking exists includes approximately 0.2 to 2 seconds. The time interval can also be longer, depending on the vehicle geometry and the properties of the systems involved.

The method according to the disclosure is described below by way of example by using the load states shown in FIGS. 1 to 3, as is the performance of the method in a brake system 1 for a vehicle 100 according to the embodiment shown in FIG. 4.

In the state shown in FIG. 2, the brake system 1 (cf. FIG. 4) monitors the angle of inclination α, in particular continuously, via the acceleration sensor 5.1. This angle of inclination α is either compared continuously with a predefined value range of 0°<α≤+/−90°, in particular with a predefined value range of 0<α≤+/−12°, via the control device 6, or only for the case in which a stress is detected by the displacement sensor 4. As a reaction to a detected stress, the brake actuators 8 are released by actuating a second target braking level via the control device 6, since the angle of inclination is α=0° and thus lies outside the predefined value range.

In the embodiment shown in FIG. 3, the semi-trailer 100 is on a slope which is inclined by the angle α=10°. The brake system 1 (cf. FIG. 4) and in particular the control device 6 in this case, as a reaction to a detected stress, will release the brake actuators 8 by actuating a first target braking level by the control device 6, since the angle of inclination is α=10° and thus lies within the predefined value range. The first target braking level can in particular be defined as a function of the state variable Z₁, that is, the angle of inclination α. The first target braking level is determined as the ratio of the necessary braking force f_{b}(α)=m·g·sin α and the weight f_{g}(g)=m·g. This results in a first target braking level of 17.4% with an angle of inclination α=10°. Thus, the brake actuator 8 can be released exactly by the electric brake system 1 with the control device 6 as a function of the detected state variable Z₁, in the present case the angle of inclination.

Furthermore, in addition to the acceleration sensor 5.1, the sensor unit 5 can include a further sensor, in particular a pressure sensor 5.2. In this case, two load states, namely a positional state and a state of loading, are taken into account when actuating the brake actuators 8. The brake system 1 is configured to monitor a first state variable Z₁, in the present case an angle of inclination α, by the acceleration sensor 5.1 of the sensor unit 5 and, in addition, a second state variable Z₂, for example an air suspension bellows pressure of the air suspension bellows 20 (cf. FIGS. 1 to 3), via the pressure sensor 5.2 of the sensor unit 5.

In this case, the brake system 1 is further configured to release the brake actuators 8 as a function of the first monitored state variable Z₁ and of the second monitored state variable Z₂ by actuating a first target braking level for the case in which the first state variable Z₁, that is, the angle of inclination α, can be assigned to the first predefined value range of 0<α≤+/−90°, in particular of 0°<α≤+/−12°, and the second target braking level, that is, the air suspension bellows pressure, can be assigned to the second predefined value range of 0.1 bar<p<10 bar, actuating a second target braking level for the case in which the first state variable Z₁ cannot be assigned to the second predefined value range, and actuating a third target braking level for the case in which the second state variable Z₂ cannot be assigned to the second predefined value range.

The second target braking level can in particular be ≤2% and >0%, in particular ≤ 1% and >0%. In this case, the semi-trailer 100 is on a level.

The air suspension bellows pressure cannot be determined unambiguously in particular when loading an empty semi-trailer 100 with the trailer 13 lowered, and thus cannot be assigned to the second predefined value range. In this case, the third target braking level is actuated which, in particular, is a value corresponding to the so-called loading characteristic curve. This is a braking level which is to be applied in the case of a fully loaded semi-trailer 100.

FIG. 5 shows a further embodiment of the vehicle 100, which is a semi-trailer in the present case. It shows the vehicle floor 22 of the semi-trailer 100 with the electro-pneumatic brake system 10 in detail. The vehicle 100 shown in FIG. 5 differs from the embodiment shown in FIGS. 1 to 4 firstly by the suspension 3, which is configured as a mechanical suspension.

In a known manner the electro-pneumatic brake system 10 has an electronically controllable pneumatic brake system 1 in conjunction with a number of electronically regulated pneumatic brake actuators 8 and a compressed air supply (not shown) for the brake actuators 8, wherein at least two brake actuators 8 are assigned to the rear axle 17. The electronically controllable pneumatic brake system 1 has the control device 6, wherein the axle modulator 25 is integrated into the control device 6 in this embodiment.

The state of loading monitored in this embodiment is a state of loading, and the state variable Z₃ is a spring compression travel of the mechanical suspension 3. In the mechanical suspension 3 of the vehicle 100 and the vehicle body 21, compression of the suspension of the vehicle 100 and of the vehicle body occurs in the event of a change in the weight or the distribution of the load of the vehicle 100 or the vehicle body, so that the state of loading is characterized by the spring compression travel Z₃.

The brake system 1 includes a brake system 1 for dissipating stresses in the braked, stationary vehicle 100 in a known manner, which has a control device 6 with integrated axle modulator, to which, amongst other things, wheel rotational speed sensors 7 are connected for detecting a stress in the vehicle 100 produced by a level change. The brake actuator 8 can be actuated via the brake system 1. Furthermore, the brake system 1 includes a sensor unit 5 with at least one height sensor 5.3 for monitoring the spring compression travel Z₃, wherein the brake actuator 8 actuates a target braking level as a function of the spring compression travel Z₃.

In the sense of the disclosure, the sensor unit 5 can also have a combination of the sensors shown in FIGS. 4 and 5 and an acceleration sensor 5.1 for monitoring the first state variable Z₁, a pressure sensor 5.2 for monitoring the second state variable Z₂ and a height sensor 5.3 for monitoring the third state variable Z₃, wherein the brake system 1 can be configured to release the brake actuator as a function of the first state variable Z₁, the state variable Z₂ and the third state variable Z₃.

It is understood that the foregoing description is that of the preferred embodiments of the invention and that various changes and modifications may be made thereto without departing from the spirit and scope of the invention as defined in the appended claims.

### LIST OF DESIGNATIONS (PART OF THE DESCRIPTION)

1 Brake system
3 Suspension
4 Displacement sensor
5 Sensor unit
5.1 Acceleration sensor
5.2 Pressure sensor
5.3 Height sensor
6 Control device
7 Wheel rotational speed sensor
8 Brake actuator
9 CAN bus system
10 Electro-pneumatic brake system
11 Tractor
12 Fifth-wheel plate
13 Trailer
14 King pin
15 Front axle
16 Rear axle
17 Axle
18 Axle swinging arm
19 Bearing point
20 Air suspension bellows
21 Vehicle body
22 Vehicle floor
23 Wheels
24 Wheels
25 Axle modulator
100 Vehicle
a Wheelbase
b Wheelbase
α Angle of inclination
Z₁ First state variable
Z₂ Second state variable
Z₃ Third state variable

1. A method for actuating a brake actuator in a braked, stationary vehicle, the method comprising the steps:
a) monitoring a state variable (Z₁, Z₂, Z₃) defining a state of loading of the vehicle;
b) detecting stress in the vehicle produced by a level change;
c) comparing the state variable (Z₁, Z₂, Z₃) with a predefined value range; and,
d) releasing the brake actuator in response to the detection of the stress, wherein:
for the case wherein the state variable (Z₁, Z₂, Z₃) is assignable to the predefined value range, actuating a first target braking level; and,
for the case wherein the state variable (Z₁, Z₂, Z₃) cannot be assigned to the predefined value range, actuating a second target braking level.

2. The method of claim 1, wherein the first target braking level is defined as a function of the state variable (Z₁, Z₂, Z₃) and the second target braking level is a discrete value.

3. The method of claim 1, wherein:
the state variable is a first state variable (Z₁), which defines a first state of loading and which, in step c), is compared with a first predefined value range; and,
at least one second state variable (Z₂) is monitored, which defines a second state of loading of the vehicle and which, in step c), is compared with a second predefined value range.

4. The method of claim 3, wherein:
in step d), the first target braking level is actuated for the case wherein the first state variable (Z₁) is assignable to the first predefined value range and the second target braking level (Z₂) is assignable to the second predefined value range; and,
in step d), a third target braking level is actuated for the case wherein the second state variable (Z₂) cannot be assigned to the second predefined value range.

5. The method of claim 1, wherein a state of loading is a positional state and a state variable (Z₁) is an angle of inclination (α) of the vehicle relative to the horizontal.

6. The method of claim 5, wherein the angle of inclination (α) is monitored by sensing an acceleration of the vehicle via a sensor unit.

7. The method of claim 5, wherein the predefined value range includes angles of inclination (α) lying in at least one of the following ranges:
i) 0°<α≤|±90°|;
ii) 0°<α≤|±12°|;
iii) 0<α≤|±7°|; and,
iv) |±7°|<α≤|±10%.

8. The method of claim 5, wherein the first target braking level is defined as a ratio of the braking force f_{b}(α)=m·g·sin α and the weight f_{g}(g)=m·g in percent, and the second target braking level assumes a value <1%.

9. The method of claim 1, wherein a state of loading is a state of loading and a state variable (Z₂) is a pressure of a suspension.

10. The method of claim 9, wherein the state of loading is monitored by sensing an air suspension bellows pressure of a pneumatic suspension or a hydraulic pressure of a hydraulic suspension via a sensor unit.

11. The method of claim 9, wherein:
the predefined value range comprises pressures in a range of 0.1 bar<p<200 bar;
the suspension is a pneumatic suspension and the predefined value range comprises pressures in a range of 0.1 bar<p<10 bar; or,
the suspension is a hydraulic suspension and the predefined value range comprises pressures in a range of 2.5 bar<p<200 bar; and,
wherein the second target braking level corresponds to the maximum target braking level in a fully loaded vehicle.

12. The method of claim 1, wherein a state of loading is a state of loading and a state variable (Z₃) is a spring compression travel of a mechanical suspension.

13. The method of claim 1, wherein in step b), stressing of the vehicle is detected for the case in which the following conditions are satisfied:
i) the vehicle is at a standstill; and,
ii) the vehicle is braked; and,
iii) a level change falls above or below a limiting value.

14. The method of claim 1, wherein the vehicle has at least one axle and wherein the axle is respectively assigned two brake actuators which, in step d), are actuated simultaneously.

15. A brake system including an electronically controllable pneumatic brake system for a vehicle for actuating a brake actuator in a braked, stationary vehicle, the brake system comprising:
a sensor unit for monitoring a state variable (Z₁, Z₂, Z₃) defining a state of loading of the vehicle;
a displacement sensor for detecting a stress in the vehicle produced by a level change; and,
a control device having a signal connection to said sensor unit and to said displacement sensor;
said control device being configured to release the brake actuator in a response to the detection of a stress and wherein at least one of the following applies:
i) for the case wherein the state variable (Z₁, Z₂, Z₃) can be assigned to the predefined value range to actuate a first target braking level; and,
ii) for the case wherein the state variable (Z₁, Z₂, Z₃) cannot be assigned to the predefined value range to actuate a second target braking level.

16. The brake system of claim 15, wherein:
a state of loading is a positional state and a state variable (Z₁) is an angle of inclination (α) of the vehicle relative to the horizontal; and,
the sensor unit has an acceleration sensor for monitoring the angle of inclination (α).

17. The brake system of claim 15, wherein:
a state of loading is a state of loading and a state variable (Z₂) is a pressure of a suspension; and,
said sensor unit has an acceleration sensor for monitoring the pressure.

18. The brake system of claim 15, wherein:
a state of loading is a state of loading and a state variable (Z₃) is a spring compression travel of a mechanical suspension; and,
said sensor unit has a displacement sensor for monitoring the spring compression travel.

19. A vehicle including a commercial vehicle, the vehicle comprising:
an axle suspended on trailing arms or semi-trailing arms; and,
a brake system for actuating a brake actuator in a braked, stationary vehicle;
said brake system including:
a sensor unit for monitoring a state variable (Z₁, Z₂, Z₃) defining a state of loading of the vehicle;
a displacement sensor for detecting a stress in the vehicle produced by a level change; and,
a control device having a signal connection to said sensor unit and to said displacement sensor;
said control device being configured to release the brake actuator in a response to the detection of a stress and wherein at least one of the following applies:
i) for the case wherein the state variable (Z₁, Z₂, Z₃) can be assigned to the predefined value range to actuate a first target braking level; and,
ii) for the case wherein the state variable (Z₁, Z₂, Z₃) cannot be assigned to the predefined value range to actuate a second target braking level.

20. The vehicle of claim 19, wherein the vehicle is a semi-trailer truck including an air-sprung semi-trailer truck having:
a tractor with an axle suspended on trailing arms or semi-trailing arms;
a trailer that can be connected to the tractor; and,
said trailer having an axle suspended on trailing arms or semi-trailing arms.
